(19) United States
(12) Patent Application Publication
(10) Pub. No.: US 2024/0026109 A1
(43) Pub. Date: Jan. 25, 2024

(54) ADHESION OF BLOWING AGENT-CONTAINING PARTICLES BASED ON POLYIMIDES OR POLYACRYLATES

(71) Applicant: Evonik Operations GmbH, Essen (DE)

(72) Inventors: Christian TRAßL, Warmensteinach (DE); Florian Hopf, Neu Isenburg (DE); Mona Ganglauf, Hoechst (DE)

(73) Assignee: Evonik Operations GmbH, Essen (DE)

(21) Appl. No.: 18/255,409

(22) PCT Filed: Nov. 16, 2021
(86) PCT No.: PCT/EP2021/081799

§ 371 Date: Jun. 1, 2023

(30) Foreign Application Priority Data
Dec. 2, 2020 (EP) 20211204.1

(51) Int. Cl. C08J 9/236; C08J 9/232; C08J 9/224; C08J 9/14; C08J 9/00

(52) U.S. Cl. CPC C08J 9/236; C08J 9/232; C08J 9/224; C08J 9/142; C08J 9/0066; C08J 9/0095; C08J 2201/034; C08J 2379/08; C08J 2333/26; C08J 2203/12

(57) ABSTRACT

A process for the production of functionalized particle foam mouldings based on a thermoplastic base material with a glass transition temperature of at least 100° C. involves functionalization of base particles.

### FIELD OF THE INVENTION

The present invention relates to a process for producing functionalized particle foam mouldings based on thermoplastic base material having a glass transition temperature of at least 100° C. comprising the functionalization of the base particles.

### PRIOR ART

Processes for producing foams from expandable granules are known to those skilled in the art. Typically, as such granules, thermoplastic blowing agent-containing particles are heated, for example with steam, whereby the blowing agent is volatilized. By means of the discharge of the blowing agent, the particles are then expanded and form a predominantly closed cell foam. These foams, often at elevated temperatures, are then pressed against one another by the particle expansion then occurring such that the individual particles acquire a certain adhesion to one another.

To the extent that functionalized foams are desired, a person skilled in the art employs a further step after production of the foam to provide functionality. For example, WO 2005/105404 A1 discloses a process for producing foams, wherein the granules used after expansion and maturation are provided with functionalization. A disadvantage in this case is that only parts of the surfaces of the individual granules are accessible such that homogeneous functionalization cannot be achieved.

A variant of this process with an additional functionalization step is described in EP 2 937 379 A1. Therein, an emulsion comprising a specific polymer is applied to the granules prior to expansion. A disadvantage of this variant is that the as yet unexpanded granules are coated and that the functionalization, particularly during the pre-expansion, i.e. the pre-foaming, can easily be lost again, especially if the coating has a different coefficient of thermal expansion to the granules. It is also barely possible to achieve as complete a coating as possible of the granules since the coating cannot expand during pre-expansion to the extent of the granules.

Alternatively, a person skilled in the art uses particles already comprising this functionality, for example applied during a master batch process. It is disadvantageous here that unused functionalities remain within the particle. This unused functionality on the one hand generates costs in the production and on the other hand burdens the environment without a technical advantage resulting therefrom.

All solutions from the prior art have in common that they require additional process steps in a disadvantageous manner which is time-consuming and costly.

### OBJECT OF THE INVENTION

Thus, there exists a need to provide an improved process for producing functionalized particles.

In particular, an object of the present invention is to overcome or at least to minimize the disadvantages of the known processes of the prior art.

One object of the present invention is the provision of functionalized, pre-foamed particles, particularly in as cost-effective and process efficient manner as possible.

### Solution

The objects of the present invention are achieved by the process according to the invention for the production of a functionalized particle foam moulding based on thermoplastic base material with a glass transition temperature of at least 100° C. comprising the process steps in the sequence specified of:
a) providing base particles comprising at least one blowing agent and at least one nucleating agent;
b) feeding the base particles into a device suitable for moving and heating the base particles;
c) simultaneously pre-foaming and functionalizing the base particles, by bringing them into contact with a solution or dispersion comprising at least one functionalizing agent, wherein the at least one functionalizing agent is an adhesive and optionally one or more further functionalizing agents are used together with the adhesive to functionalize the base particles, and the particles are treated with a solution or emulsion of water and/or solvent and at least one functionalizing agent,
so that functionalized particles are obtained which have at least partially an adhesive layer and optionally one or more functionalizations on their surface;
d) optionally drying the functionalized particles;
e) optionally intermediate storage of the functionalized particles;
f) mould foaming of the functionalized particles by heating in a shaping container so that a functionalized particle foam moulding is formed solved.

Advantageous embodiments of the process according to the invention are listed in the following description and in the dependent claims.

Advantageously, the present invention has proven to be particularly process efficient since additional process steps can be omitted. As a result, the process is also cost-efficient since working steps and time are saved. Also, no additional equipment is required to carry out possible additional process steps.

The functionalization and the pre-foaming take place according to the invention in one process step such that an additional functionalization step can be omitted. The present invention also has the advantage that the functionalization very uniformly encompasses all functional particles such that homogeneous functionalization is present.

Process Step a)

The base material of the base particle is thermoplastic. The base material is preferably selected from the group consisting of polyimides and polyacrylates, preferably polymethacrylimides (PMI), polyetherimide (PEI), polymethyl (meth)acrylate (PM(M)A) and mixtures of the above.

In particular, the base material also does not comprise any polyolefin, especially no polypropylene. Polyolefins have a glass transition temperature below 50° C., and are therefore unsuitable as base material for structural foams for high temperature applications.

The base material has a glass transition temperature of at least 100° C. The base material preferably has a glass transition temperature of at least 180° C. The glass transition temperature of the base material typically refers to the pure base material, not to the base material comprising the blowing agent. Glass transition temperatures are typically measured by DSC according to DIN EN ISO 11357-2 (published: 2014-07), at a heating rate of 10 K/min.

The base particles comprise at least one blowing agent. Typically, the at least one blowing agent is present in the base material, for example solved. The at least one blowing agent serves the purpose, under certain conditions such as elevated temperatures for example, of expanding the base particles. This expanding refers to the volume increase of the base particles.

The blowing agent is selected from the group consisting of volatile organic compounds having a boiling point at standard pressure below the glass transition temperature of the base material, inorganic blowing agents, thermally decomposable blowing agents and mixtures of the above.

The volatile organic compound having a boiling point at standard pressure below the glass transition temperature of the base material and which is liquid at standard temperature (i.e. 25° C., 1013 mbar), is preferably selected from the group consisting of non-halogenated hydrocarbons, ketones, alcohols, halogenated hydrocarbons and mixtures of the above.

The ketone is preferably selected from acetone, methyl ethyl ketone, cyclohexanone, cyclononanone, diacetone alcohol and mixtures of the above. The ketone is more preferably selected from acetone, methyl ethyl ketone and mixtures of the aforementioned.

The non-halogenated hydrocarbon preferably comprises 4 to 8 carbon atoms. The non-halogenated hydrocarbon is more preferably selected from butane, pentane, hexane and mixtures of the aforementioned.

The alcohol is preferably selected from methanol, ethanol, isopropanol, n-propanol and mixtures of the aforementioned.

Blowing agents used for polymethacryl imides may be the following compounds or mixtures thereof: formamide, formic acid, urea, itaconic acid, citric acid, dicyandiamide, water, monoalkylureas, dimethylurea, 5,5′-azobis-5-ethyl-1,3-dioxane, 2,2′-azobis-N-butylisobutyramide, 2,2′-azobis-N-diethylisobutyramide, 2,2′,4,4,4′,4′-hexamethyl-2,2′-azopentane, 2,2′-azobis-2-methylpropane, dimethyl carbonate, di-tert-butyl carbonate, acetone cyanohydrin carbonate, methyl hydroxyisobutyrate carbonate, N-methylurethane, N-ethylurethane, N-tert-butylurethane, urethane, oxalic acid, maleic acid, hydroxyisobutyric acid, malonic acid, cyanoformamide, dimethylmaleic acid, tetraethyl methanetetracarboxylate, n-butyl oxamate, trimethyl methanetricarboxylate, triethyl methanetricarboxylate, and also monohydric alcohols of 3 to 8 carbon atoms such as, for example, propan-1-ol, propan-2-ol, butan-1-ol, butan-2-ol, tert-butanol and isobutanol.

For polymethyl(meth)acrylate it is also possible to use copolymerizable blowing agents, which release a volatile compound under the conditions of foaming and in general thereafter remain in the form of repeating (meth)acrylic acid units in the polymer. Examples of such copolymerizable blowing agents, which are common knowledge, are isopropyl (meth)acrylate and tert-butyl (meth)acrylate.

Particularly suitable blowing agents comprise tert-butanol, n-heptane, MTBE, methyl ethyl ketone, an alcohol having from one to four carbon atoms, water, methylal, urea, tert-butyl methyl ether, isopropyl (meth)acrylate and/or tert-butyl (meth)acrylate. Particulary suitable blowing agents are tert-butyl (meth)acrylate, isopropyl (meth)acrylate, tert-butanol, isopropanol and poly(tert-butyl (meth)acrylate).

The ester is preferably selected from the group consisting of methyl acetate, ethyl acetate, butyl acetate, and mixtures of the aforementioned.

The halogenated hydrocarbon is preferably selected from the group consisting of methyl chloride, ethyl chloride, dichloromethane, dichloroethane, dichlorodifluoromethane, dichlorotetrafluoroethane, trichlorofluoromethane, trichlorotrifluoroethane and mixtures of the aforementioned.

The at least one blowing agent is particularly preferably selected from the group consisting of non-halogenated hydrocarbons, ketones, alcohols and mixtures of the aforementioned. The at least one blowing agent is most preferably a ketone or urea.

If the at least one blowing agent is an inorganic blowing agent, it is preferably selected from carbon dioxide, argon and mixtures of the aforementioned.

If the at least one blowing agent is a thermally decomposable blowing agent, it is preferably selected from azodicarbonamide, p-toluenesulfonyl semicarbazide, 5-phenyltetrazole and mixtures of the aforementioned. The thermally decomposable blowing agent has a decomposition temperature from which it releases a gas so that the base particles can then expand.

The base particles typically comprise (on average) 1 to 20% by weight, preferably 7 to 15% by weight blowing agent, based on the total mass of the base particles.

The base particles comprise a nucleating agent. This nucleating agent is preferably selected from the group consisting of talc, graphite, carbon black, titanium dioxide, nanoparticle (nanotubes, nanoplates etc.) and mixtures of the aforementioned. The optional nucleating agent advantageously improves the cell morphology.

Nucleating agents used for polymethacrylimide foams may be the following compounds or mixtures thereof: inorganic salts and minerals insoluble in the reaction mixture, e.g. SiO₂, ZnS, BPO₄, NaCl, KCl or inorganic polymers and their salts, e.g. ammoniumpolyphosphate.

The base particles comprise (on average) 0.01 to 3% by weight, preferably 0.05 to 1% by weight nucleating agent, based on the total mass of the base particles.

The base particles are preferably spherical or cylindrical. Spherical means that the base particles have no corners or edges. The ratio of the shortest to longest diameter of the spherical base particles is preferably in the range of 0.9 to 1.0, particularly preferably in the range of 0.95 to 0.99.

By virtue of the spherical shape, the preferred spherical base particles and the functional particles obtained by pre-foaming can be easily conveyed by pneumatic conveying systems and can be blown into foam moulds.

The diameter of the base particles, preferably of the preferred spherical or cylindrical base particles, is preferably in the range of 0.1 to 5 mm, more preferably in the range of 0.5 to 3 mm, especially preferably between 0.8 and 2 mm.

The dimensions of the cylindrical base particles are defined by the diameter thereof, to which the same applies as for the spherical base particles, and the height thereof. In the case of the cylindrical base particles, the ratio of height to diameter is preferably in the range of 0.9 to 1.1, particularly preferably the cylindrical base particles have a diameter equal to their height. The base particles are not hollow particles and not core-shell particles, like micropheres.

The average mass of the base particles is preferably 1 to 15 mg, more preferably 2 to 12 mg, especially 3 to 10 mg. In this case, the mass of the base particles is at least 50%, preferably 75%, especially 90%, in the range specified above.

Preferably, 90% of the base particles, particularly preferably 99% of the base particles, based on the total number of base particles, have a diameter of less than 5 mm.

The base particles and the preparation process thereof are known in the prior art or are commercially available. A person skilled in the art can choose from various methods. For example, base particles can be obtained as follows: After melting a base material in an extruder, the nucleating agent, if desired, is added and on cooling the base material, the at least one blowing agent. The base particles can then be formed mechanically, e.g. using a perforated plate, gear pump or the like (cf. WD 2019/025245, page 3, lines 19-38).

Process Step b)

In process step b) of the process according to the invention, the base particles are fed to a device suitable for moving and heating of the base particles.

Suitable devices in the context of the invention are, for example, rotatable heatable drums, mixing vessels or also a moving belt in combination with a heat source, preferably a pass-through oven. The moving belt is, for example, a conveyor belt which feeds the base particles to the heat source. In this context, it is advantageous if the conveyor belt comprises a means for moving the base particles relative to one another, for example a vibrating device, whereby the base particles are moved back and forth on the belt.

The device is preferably a rotatable heatable drum or a mixing vessel. In particular, the device is a rotatable heatable drum. Such drums have the lowest mechanical influence on the base particles and the functional particles paired with a very efficient mixing of the base particles.

The device is suitable for moving of the base particles. This means the directed movement of the base particles in one direction (for example on a conveyor belt through an oven) and/or movement of the base particles relative to one another. The latter is preferably included. As a result, improved functionalization of the base particles is possible.

In order to feed the base particles to the device, numerous possibilities are known to those skilled in the art. For example, they can be fed manually (casting, pouring, shoveling) or by mechanical aid of the device, for example by means of a pump system. Depending on the device, the base particles are placed in the interior of the device (e.g. in the case of a rotatable, heatable drum or a mixing vessel) or placed on a section of the device (e.g. on the conveyor belt so that the base particles can be fed to a heat source).

The device has the possibility of heating the base particles. Numerous methods for this purpose are known to those skilled in the art. For example, it is possible to use suitable IR radiation sources, radio waves, microwaves, hot air, one or more resistance ovens or combinations of the aforementioned. The heat can be transferred directly (e.g. by radiation) or indirectly (e.g. by a wall of a rotatable, heatable drum or a mixing vessel heated by means of steam or similar heat sources) to the base particles.

Process Step c)

In process step c) of the process according to the invention, the base particles are simultaneously pre-foamed and functionalized.

Consequently, functionalized particles are obtained from the base particles. The functionalized particles are pre-foamed and comprise functionality on at least a part of their surface. Preferably, at least 20%, more preferably 40% of the surface (based on the total surface of the functionalized particles) are provided with functionalization. This can be determined gravimetrically or spectroscopically—depending on the particle and the functionalization.

The functionalized particles according to the invention differ from the pre-expanded granules known in the prior art, inter alia, by the functionalization applied to the surface.

The functionalized particles also still comprise a portion of the blowing agent that the base particles comprised. Preferably, the functionalized particles comprise 5 to 12% of the blowing agent of the base particles, more preferably 6 to 10%, even more preferably 7 to 9%.

The base particles are functionalized during the pre-foaming by bringing them into contact with a solution or dispersion comprising at least one functionalizing agent. The functionalization preferably only takes place during the pre-foaming so that the process according to the invention can be particularly efficiently designed. The functionalizing agent generates functionality on at least a part of the surface of the base particles.

The base particles are brought into contact with the solution or dispersion comprising at least one functionalizing agent by dipping, spraying or by other common methods. In this regard, a person skilled in the art can determine the most suitable method by routine experiments.

The solution or dispersion comprising the at least one functionalizing agent is preferably aqueous. Aqueous signifies in this case that at least 90% by weight, more preferably at least 99% by weight of all solvent of the solution or dispersion is water. Further solvents miscible with water can be mixed in, such as acetone, alcohols (preferably alcohols comprising 1 to 4 carbon atoms, more preferably alcohols comprising 2 to 3 carbon atoms) or glycols (preferably ethylene glycol and propylene glycol), in order to improve the solubility of individual components for example or to improve the stability of a dispersion.

The functionalizing agent is preferably selected from the group consisting of biocides, fungicides, adhesives, fibers, dyes, pigments, electrically conductive particles and mixtures of the above.

Preferred biocides are antibacterial agents of which silver is preferred. Preference is given to using silver having a d50 of ≤1 μm, more preferably having a d50 of 250 nm. The d50 can be determined by dynamic light scattering methods such as described in “Measuring the Size of Nanoparticles in Aqueous Media Using Batch-Mode Dynamic Light Scattering”, NIST Special Publication 1200-6 (Version 1.2, May 2015).

Fungicides are organic, inorganic or organometallic materials. Preferred fungicides are copper compounds, for example copper oxychloride, colloidal, pure sulfur, azoles, morpholine or strobilurine.

Suitable adhesives are in particular able to bond the individual functional particles to one another in a further subsequent process step, ideally to bond to one another cohesively. In accordance with the invention, the adhesives are preferably selected from the group consisting of dextrin, casein, acrylic resins, vinyl acetate resins, polyester resins, polyurethane resins, polyvinyl alcohol resins, isocyanates, polyamide resins, of mixtures and copolymers of the aforementioned. Alternatively, thermoplastic polymers may used for adhesives.

In a preferred embodiment, the at least one functionalizing agent is an adhesive. Optionally, the adhesive is used together with one or more further functionalizing agents (selected from the group defined above). For example, an adhesive and a biocide are used together as functionalizing agent. Particularly advantageously, this embodiment of the present invention permits the formation of possible defects (also known to those skilled in the art as blowholes or gussets) during shaping (process step f)) to be reduced or even completely prevented. This applies particularly in the case of shaping with sintering using (supersaturated) steam since in this case in particular occasional conflicting phenomena can occur in the base materials present. Since the temperature of the steam increases proportionately with the pressure, there may be occasions when the process temperature required for sufficient sintering of the functional particles results in that self-expansion cannot take place, or only to an insufficient extent, due to excessively high steam pressure. If a certain degree of self-expansion in process step f) is not achieved, this may result in two aspects:

1. The sintering of the functionalized particles may be insufficient because the surfaces of adjacent functionalized particles are not pressed together strongly enough.

2. The functionalized foam may possibly have defects in the form of blowholes because the space between the functionalized particles cannot be filled since, as already described, the volume of the functionalized particles cannot be sufficiently increased, if at all. A non-homogeneous structure of the functionalized foam is the consequence. This effect has a particularly negative impact on the surface quality of the functionalized foam. In addition to possible optical impairment especially in downstream processes such as in the optional application of top layers or films to the functionalized foam, this can in turn lead to problems (excessive resin uptake in fiber-reinforced top layers and thus to component dimensions that are too high, show throughs of the blowholes through decorative fabrics or films). These possible disadvantages can be advantageously avoided or at least reduced, particularly by this embodiment.

In the case of an adhesive as the at least one functionalizing agent and the use of the temperature of the (supersaturated) steam for sintering the functionalized particle, the blowing agent is preferably selected such that its boiling point is less than or equal to the temperature selected in which the adhesive develops its adhesion, i.e. for example an appropriate reaction takes place if a reactive adhesive is selected. At the same time, the latter temperature mentioned should be below the sintering temperature of the base material comprising the at least one blowing agent.

When using thermoplastic polymers as adhesives, the softening point or melting point is less than or equal to the processing temperature.

Suitable fibers are selected from the group consisting of carbon fibers, glass fibers, aramid fibers, basalt fibers and mixtures of the aforementioned. The fibers particularly improve the mechanical stability of the functional particles and functionalized foams generated therefrom. As a result, a subsequently applied laminate can sometimes be omitted.

Suitable dyes serve to colour the functionalized particles and functionalized particle foam mouldings generated therefrom and are preferably selected from the group consisting of organic dyes.

Suitable pigments serve to colour the functional particles and functionalized particle foam mouldings generated therefrom or impart other functionalities such as increased UV resistance. One difference to the aforementioned dyes consists in that pigments cannot generally be dissolved in a solvent (preferably water in accordance with the invention) and therefore have to be dispersed. A preferred example for increasing the UV resistance is the use of nanoparticulate titanium dioxide in the rutile form.

Suitable electroconductive particles are selected from the group consisting of conductive carbon black, graphite, graphene and carbon nanotubes (CNT). The electroconductive particles impart electrical conductivity to the functionalized particles and functionalized particle foam mouldings generated therefrom or, depending on the amount applied, at least an antistatic coating.

A person skilled in the art selects the amount of the at least one functionalizing agent in the solution or dispersion, inter alia, depending on the desired functionalizing agent, the amount to be applied to the surface of the base particle and the temperature used. Typical amounts are 0.1 to 50% by weight, preferably 1 to 30% by weight, more preferably 5 to 10% by weight, based on the total amount of the solution or dispersion.

Optionally, the solution or dispersion additionally comprises further additives such as wetting agents, stabilizers or rheological additives. These additives and use thereof are known and they are commercially available.

Suitable solutions or dispersions are sometimes commercially available or can be prepared by standard methods. For example, the functionalizing agent and further additives such as wetting agents, stabilizers or rheological additives can be dissolved in the solvent or dispersed therein.

Preparation methods of this kind are known to the person skilled in the art.

The duration of process step c) is preferably in the range of 1 s to 15 min, preferably in the range of s to 10 min, more preferably in the range of 10 s to 5 min. Durations outside the ranges mentioned can also be applied depending on the temperature used and the functionalizing agent.

Process step c) is carried out in the device of process step b). The temperature in the interior of the device in process step c) is typically between the boiling point or the decomposition point (at standard conditions) of the blowing agent and the glass transition temperature of the base material.

The temperature in the interior of the device in process step c) is preferably in the range of at least 10° C. above the boiling point or the decomposition point (at standard conditions) of the blowing agent and a temperature of up to 10° C. below the glass transition temperature of the base material.

For example, the temperature in the interior of the device in process step c) is in the range of 56° C. to 230° C., preferably in the range of 65° C. to 200° C., if acetone is used as blowing agent, talc as nucleating agent and polyetherimide as base material. The temperature in process step c) can be adjusted by the methods described above.

The base particles are pre-foamed by the temperature set in the interior of the device. Due to the temperature set, a portion of the blowing agent present in the base particles is converted to the gas phase and expelled from the base particles, whereby these undergo volume expansion. This is referred to in accordance with the invention as pre-foaming. This pre-foaming differs from the final foaming (in process step f)) in that the particles subsequently still comprise blowing agent and, by means of a subsequent expansion, a further volume increase and sintering takes place or can take place.

An advantage of the present invention is that the growing surface of the base particles dung the pre-foaming is also further in contact with the solution or dispersion comprising the at least one functionalizing agent such that any defects, such as cracks or flaking in the functionalization layer, are immediately repaired again.

In a preferred embodiment, the base particles in process step b) are fed to a heatable, rotatable drum and in process step c) are sprayed with a solution or dispersion comprising the at least one functionalizing agent while the drum is heated and rotated, whereby the base particles are moved against each other during the pre-foaming and functionalization. This preferred embodiment allows a particularly efficient implementation of the process according to the invention and a particularly homogeneous functionalization of the base particles.

According to the invention, the functionalized particles can be directly fed to process step f) the mold foaming process.

Process Step d)

The process according to the invention preferably comprises a further process step d) after process step c):
d) optionally, drying the functionalized particles.

The functionalized particles are dried in process step d) until the solvent of the solution or dispersion comprising the at least one functionalizing agent has been substantially removed. This means that preferably at least 90% by weight of the solvent adhering to the functionalized particles after process step c), preferably at least 99% by weight, is removed in process step d).

Typically, the drying is carried out at an elevated temperature, for example in the range of 25 to 90° C., preferably 40 to 60° C., in order to guarantee an efficient removal of the solvent without damaging the functionalized particles by a temperature potentially too high.

The duration of the drying is selected depending on the desired degree of removal of the solvent and the temperature. Typical drying times are in the range of 1 min to 10 days.

Numerous methods are available for selection to those skilled in the art for the implementation. For example, the functionalized particles after releasing or removing the solution or dispersion comprising the at least one functionalizing agent remain in the device suitable for moving and heating the base particles and the temperature can be adjusted accordingly. Alternatively, the functionalized particles can be transferred to an oven or the like for this purpose.

Drying has the advantage that the functionalized particles remain free-flowing, hence clumping (agglomeration) is prevented.

Preferably, the amount of solvent adhering to the functionalized particles after process step c) is already so low that process step d) is not necessary since, by virtue of the conditions prevailing in process step c), the majority of the solvent has already been removed.

Process Step e)

The process according to the invention preferably comprises a further process step e):
e) optionally, interim storage of the functionalized particles.

Process step e) is carried out after process step c) or, if process step d) of the process according to the invention is included, after the latter.

By means of process step e), pressure equalization between the functionalized particles and surrounding environment advantageously takes place. During the pre-foaming, the blowing agent is heated and expands. After completion of the pre-foaming, it recondenses again. This condensing blowing agent results in a negative pressure in the foam cells, this has a negative impact at the foam moulding. This is prevented by means of process step e) since surrounding air diffuses into the functional particles.

Typically, temperatures in the range of 0 to 30° C., preferably 15 to 25° C. are used. Excessively high temperatures may possibly lead to undesirable emission of blowing agent.

The duration is not further restricted and the functionalized particles may be placed in interim storage as long as desired. Depending on the base material used and the amount of blowing agent emitted, the duration of interim storage is determined by the person skilled in the art, for example 30 min to 72 h, preferably 2 h to 48 h, more preferably 4 h to 24 h.

Process Step f)

The process according to the invention comprises a further process step f):
f) moulding the functionalized particles by heating in a shaping container, to form a functionalized particle foam moulding

Process step f) is incorporated in the process according to the invention after process step c) or, if process step d) is included, after that, or if process step e) is included, after the latter.

The shaping of pre-expanded granules is known to those skilled in the art.

For shaping, at least two functionalized particles are heated. Generally, a multiplicity of functionalized particles are heated. The amount of functionalized particles depends on the desired shape. The temperature used for this purpose is primarily based on the base material, the blowing agent present therein and the method used. Typically, it is set in a range above the glass transition temperature of the functionalized particles, preferably up to a temperature of 10° C. above the glass transition temperature of the base material, preferably above the glass transition temperature of the functionalized particles up to the glass transition temperature of the base material. A temperature significantly above that specified can lead to unwanted melting of the functionalized particles, whereupon the shape can be lost.

The duration of the shaping is primarily based on the base material, the blowing agent present therein and the method used. A person skilled in the art can determine suitable durations by routine experiments or take them from the prior art. Typically the duration is 10 s to 120 min.

The shaping container can be, for example, a press or another suitable vessel and is determined, inter alia, by the desired shape of the functionalized foam.

After shaping, a top layer or film is optionally applied to the functionalized particle foam formed. Such top layers and films and their application methods are known to those skilled in the art.

Functionalized Particles

In another aspect, the present invention relates to functionalized particles, preferably producible or produced by means of the process according to the invention, comprising at least one blowing agent, at least one nucleating agent and at least one thermoplastic base material having a glass transition temperature of at least 100° C. and at least one functionality on at least a part of the surface thereof.

Functionalized Particle Foam Mouldings

In a further aspect, the present invention relates to a functionalized particle foam moulding produced from the functionalized particles. The functionalized particle foam moulding is preferably produced by the process according to the invention which additionally comprises at least process step f).

The functionalized particle foam mouldings comprises at least two, generally a multiplicity of cells, which have resulted from the functionalized particles in process step c). Typically, each functionalized particle forms one cell of the functionalized particle foam mouldings. The mean cell diameter of the expanded functionalized particle foam mouldings according to the invention is generally in the range of 30 to 500 μm, preferably in the range of 50 to 300 μm. Preferably, 90% of the cells, particularly preferably 99% of the cells have a cell diameter of less than 150 μm. The mean length/width ratio is preferably below 2.0, more preferably below 1.6, particularly preferably 0.9 to 1.1.

The functionalized particle foam mouldings thus obtained are generally closed cell. They preferably have a density in the range of 20 to 250 kg/ma, particularly preferably in the range of 40 to 150 kg/m.

The functionalized particle foam mouldings according to the invention are suitable for use in the production of goods for the aerospace industry, for shipbuilding, for wind power, sport and leisure equipment, for vehicle construction, especially in electrical mobility.

The functionalized particles and the functionalized particle foam mouldings generated therefrom are suitable, for example, for the production of automotive parts such as sun visors, column claddings, roof linings, boot and spare wheel covers or parcel shelves. General examples are furthermore: semi-finished products for production of furniture (e.g. panels) and furniture itself, toys, outdoor objects, machine claddings and the like.

The process according to the invention and the functionalized particles and functionalized particle foam mouldings generated therefrom are particularly suitable for high temperature applications.

### EXAMPLES

### Example 1

base polymer: polyetherimide (type: ULTEM™ 1000, manufacturer: SABIC)
nucleating agent: talc (type Luzenac, manufacturer: IMERYS)
blowing agent: acetone
functionalization: biocides (e. g. silver)
pre-foaming furnace: rotary furnace with IR-radiation field (type: IRD90/100, manufacturer: Kreyenborg GmbH)
reaction speed: 30 min⁻¹
pre-heating: 90° C. for 15 minutes
pre-foaming: 155° C. for 5 minutes
additive metering reactive solution: 0.1 l/min for 2 minutes
bulk density base particles: 740 kg/m³
bulk density functionalized particles: 90 kg/m³

After melting polyetherimide (type: ULTEM™ 1000, manufacturer: SABIC) in an extruder, the nucleating agent talc (type Luzenac, manufacturer: IMERYS) is added and on cooling the base material, the blowing agent acetone. The base particles can then be formed mechanically, by using a perforated plate.

The base particles are fed to a heatable, rotatable oven (rotary furnace with IR-radiation field (type: IRD90/100, manufacturer: Kreyenborg GmbH)) and in process step c) are sprayed with a dispersion comprising the functionalizing agent silver (biocides) while the drum is heated and rotated, whereby the base particles are moved against each other during the pre-foaming and functionalization. This preferred embodiment a particularly homogeneous functionalization of the base particles.

### Example 2

base polymer: polymethacrylimide (type ROHACELL® Triple F, manufacturer: Evonik)
glass transition temperature: 217° C. (measured by DSC according to DIN EN ISO 11357-2
(publication date: 2014-07),
nucleating agent: SiO₂
blowing agent: urea
functionalization: adhesive (type Dynacoll, manufacturer: Evonik)
pre-foaming furnace: continuous furnace with IR-radiation field (manufacturer: Fill GmbH)
conveyor speed: 0.5 m/min
pre-heating: -
pre-foaming: 210° C. continuous
additive metering reactive solution: 0.1 l/min continuous
bulk density base particles: 600 kg/m³
bulk density functionalized particles: 140 kg/m³

After melting polymethacrylimide (type ROHACELL® Triple F, manufacturer: Evonik) in an extruder, the nucleating agent SiO₂ is added and on cooling the base material, the blowing agent urea. The base particles can then be formed mechanically, by using a perforated plate.

The base particles are fed to a heatable, rotatable oven (continuous furnace with IR-radiation field (manufacturer: Fill GmbH)) and in process step c) are sprayed with a dispersion comprising the functionalizing agent adhesive (type Dynacoll, manufacturer: Evonik) while the drum is heated and rotated, whereby the base particles are moved against each other during the pre-foaming and functionalization. This preferred embodiment a particularly homogeneous functionalization of the base particles.

1: A process for production of a functionalized particle foam moulding based on thermoplastic base material with a glass transition temperature of at least 100° C. measured by DSC according to DIN EN ISO 11357-2, published: 2014-07, the process comprising in the sequence specified:
a) providing base particles comprising at least one blowing agent and at least one nucleating agent;
b) feeding the base particles into a device suitable for moving and heating the base particles;
c) simultaneously pre-foaming and functionalizing the base particles, by bringing the base particles into contact with a solution or dispersion comprising at least one functionalizing agent,
wherein the at least one functionalizing agent is an adhesive and, optionally, one or more further functionalizing agents are used together with the adhesive to functionalize the base particles, and
wherein the base particles are treated with a solution or emulsion of water and/or solvent and the at least one functionalizing agent,
so that functionalized particles are obtained which have at least partially an adhesive layer and, optionally, one or more functionalizations on their surface;
d) optionally, drying the functionalized particles;
e) optionally, interim storing of the functionalized particles; and
f) mould foaming of the functionalized particles by heating in a shaping container so that a functionalized particle foam moulding is formed.

2: The process according to claim 1, wherein the base material is selected from the group consisting of polyimide, polyacrylate, and mixtures thereof.

3: The process according to claim 1, wherein the at least one blowing agent is selected from the group consisting of volatile organic compounds having a boiling point at standard pressure below a glass transition temperature of the base material, inorganic blowing agents, thermally decomposable blowing agents, and mixtures thereof.

4: The process according to claim 1, wherein the at least one functionalizing agent is selected from the group consisting of biocides, fungicides, adhesives, fibers, dyes, pigments, electrically conductive base particles, and mixtures thereof.

5: A method for production of a part for the aerospace industry, for shipbuilding, for wind power, sport and leisure equipment, or for vehicle construction, the method comprising:
forming the part with the functionalized particle foam moulding produced by the process according to claim 1.

6: The process according to claim 2, wherein the base material is selected from the group consisting of polymethacrylimide (PMI), polyetherimide (PET), polymethyl (meth)acrylate (PM(M)A), and mixtures thereof.

7: The method according to claim 5, wherein the part is an electrical mobility vehicle part.
